(19) United States
(12) Patent Application Publication
(10) Pub. No.: US 2026/0311164 A1
(43) Pub. Date: Oct. 8, 2026

(54) TRANSFERRING DIGITAL WALLETS

(71) Applicant: American Express Travel Related Services Company, Inc., New York, NY (US)

(72) Inventors: Ajay Babu Maddukuri, Phoenix, AZ (US); Mukund Shankar SimhaRaghu, Glendale, AZ (US)

(21) Appl. No.: 19/170,002

(22) Filed: Apr. 3, 2025

(51) Int. Cl. G06Q 20/36; H04L 9/08

(52) U.S. Cl. CPC G06Q 20/36; H04L 9/0825

(57) ABSTRACT

Disclosed are various embodiments for transferring a digital wallet from a first device to a second device. First, the first device and the second device can establish a connection. Next, the first device can identify a digital wallet to be transferred, where the digital wallet having a first public key and a private key. The first device can generate an encrypted private key using a transfer key and send the encrypted private key to the second device. Using the encrypted private key, the second device can set up the digital wallet.

### BACKGROUND

Digital wallets are secure software applications which can store one or more various forms of credentials. For example, digital wallets can store proof of identity, payment methods, mobile tickets, as well as other forms of credentials. To transmit verification data for these credentials, digital wallets can use the wireless capabilities of the host device, such as WiFi, Bluetooth, Near-field Communication (NFC), Magnetic Secure Transmission (MST), or through other means such as scanning of specialized bar codes.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C are pictorial diagrams of example of interactions between client devices according to various embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a sequence diagram illustrating one example of interactions between components in the network environment of FIG. 2 according to various embodiments of the present disclosure.

### DETAILED DESCRIPTION

Disclosed are various approaches for transferring digital wallets from one device to another. Since digital wallets are provisioned on a particular device, the wallet and associated credentials are provisioned to that device and associated with the identifier of that device. Thus, in order to ‘transfer’ a digital wallet from a first device to a second device, a new wallet would need to be provisioned on the second device and the credentials of the first wallet would be transferred to the new wallet. This would require the manual re-entry of data and settings. Additionally, the new wallet would need to be registered with the appropriate entities and the identifiers of the new device added to the necessary databases in order to publicly record the transfer. This process not only requires the time-consuming reprovisioning of a wallet, but also requires extended user intervention and prolonged computing power in the generation of a new digital wallet and the step-by-step transfer of the credentials from the old wallet to the new wallet.

Accordingly, various embodiments of the present invention provide for the ability to transfer a wallet to a new device without the need to provision a new wallet and register new identifiers to the wallet. Rather, through the use of transfer keys, a private key of the digital wallet can be encrypted and directly transferred to the new device. Thus, no additional registration would be necessary since the new wallet would have the private key of the original wallet. Further, utilizing the wireless capabilities of the device on which the wallet is stored, the present invention provides for an automatic transfer of a digital wallet over secure channels while requiring minimal user input. Thus, both the user experience and the computing process is streamlined to enhance efficiency, accuracy, and security of the process.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

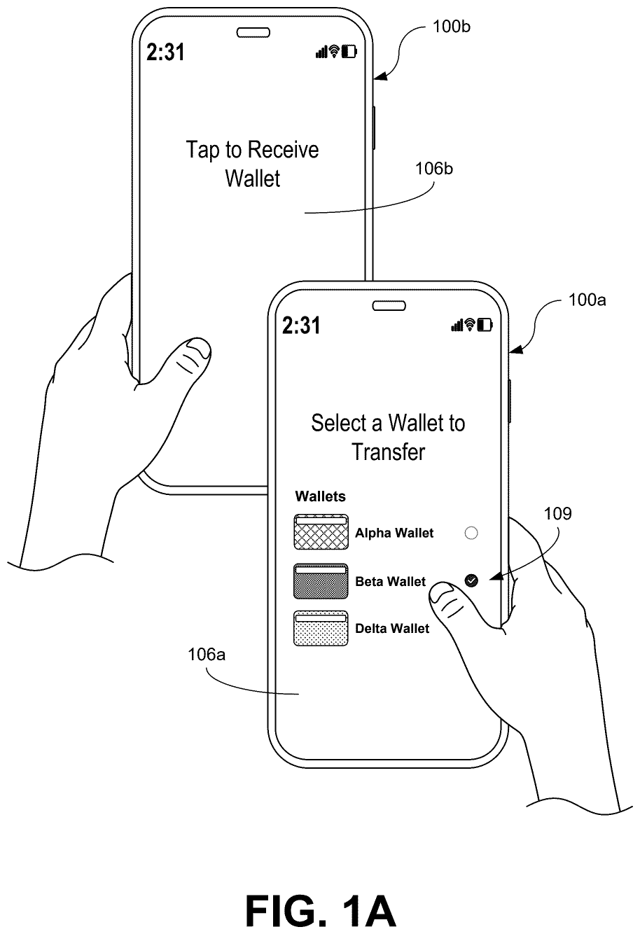

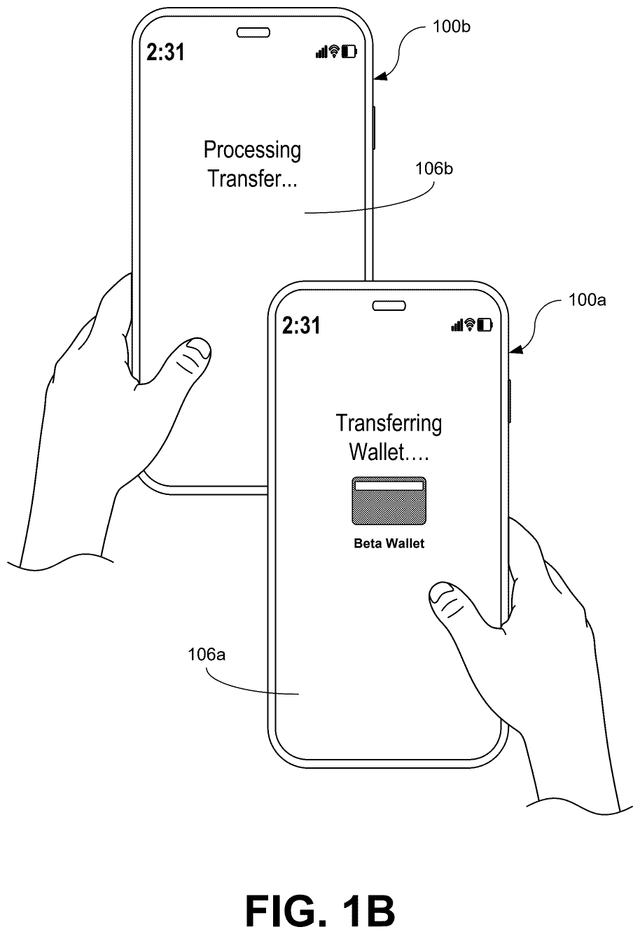

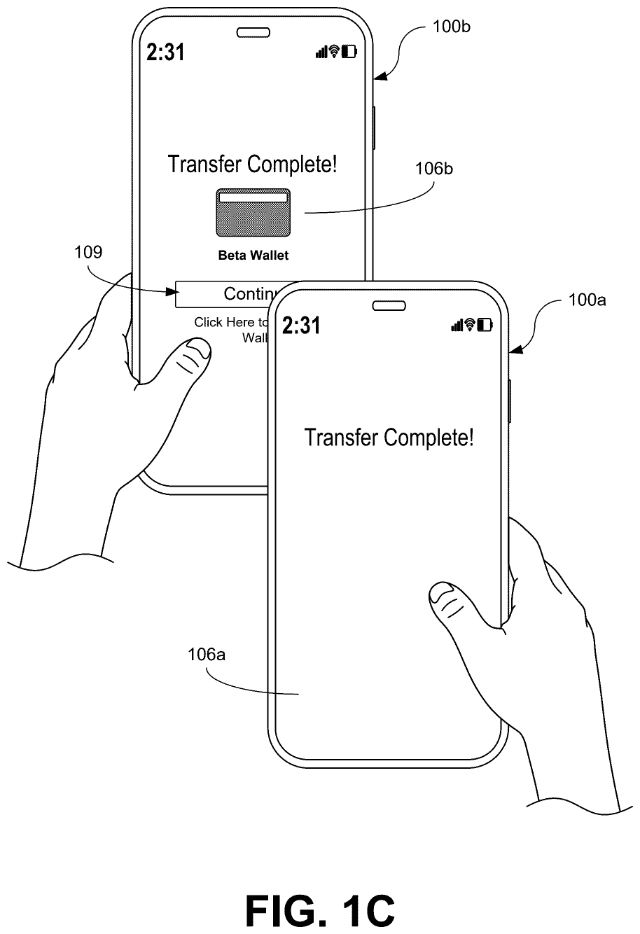

As illustrated in FIG. 1A, a user can tap their client device 100a to another client device 100b to begin the transfer of a digital wallet. A user may wish to transfer a digital wallet from an old device to a new device, or from their device to the device of a trusted individual. The client devices 100 (e.g., 100a, 100b) can interact via a secure short-range wireless connection such as a near-field communication (NFC) connection, a magnetic secure transmission (MST) connection, a BLUETOOTH® connection, an ultrawideband (UWB) connection, a WiFi connection, or other form of short-range wireless connection.

Once a connection has been established between the client devices 100, the transferring client device 100a can be configured to present in the user interface 106a one or more digital wallets available to transfer. The user can select a digital wallet by interacting with a user interface element 109. The user interface element 109 can represent a field for entering a name, number, or value, a button, a toggle, a slide, or another form of user interface element 109.

Moving to FIG. 1B, shown is another example of user interfaces 106 (e.g., 106a, 106b) shown on client devices 100 (e.g., 100a, 100b). Once the user interface element 109 of FIG. 1A is selected by the user, the corresponding digital wallet can be transferred to the receiving client device 100b through a series of behind-the-scenes steps described further on. While this process is occurring, each of the client devices 100a and 100b can be configured to display a transfer message in the user interface 106a and 106b. The transfer message can comprise a message, notification, graphic, or other user interface 106 which indicates to the user that the transfer is processing. While FIG. 1B shows user interface 106a as displaying a different transfer message than user interface 106b, there are some examples, where both client devices 100a and 100b show the same transfer message.

Moving to FIG. 1C, shown is another example of user interfaces 106 (e.g., 106a, 106b) shown on client devices 100 (e.g., 100a, 100b). After the back-end process of transferring the digital wallet is completed, the transferring client device 100a and the receiving client device 100b can both be configured to display completion messages on their respective user interfaces 106 (e.g., 106a, 106b). The completion message can comprise a message, notification, graphic, or other user interface 106 which indicates to the user that the transfer of the digital wallet has been completed successfully. Once the transfer is complete, the transferring client device 100a will no longer have any access to the digital wallet. The receiving client device 100b will have full access to the digital wallet and all associated credentials. In some examples, the user interface 106b of the receiving client device 100b can include a user interface element 109 to allow the user to view the newly transferred digital wallet and all associated credentials.

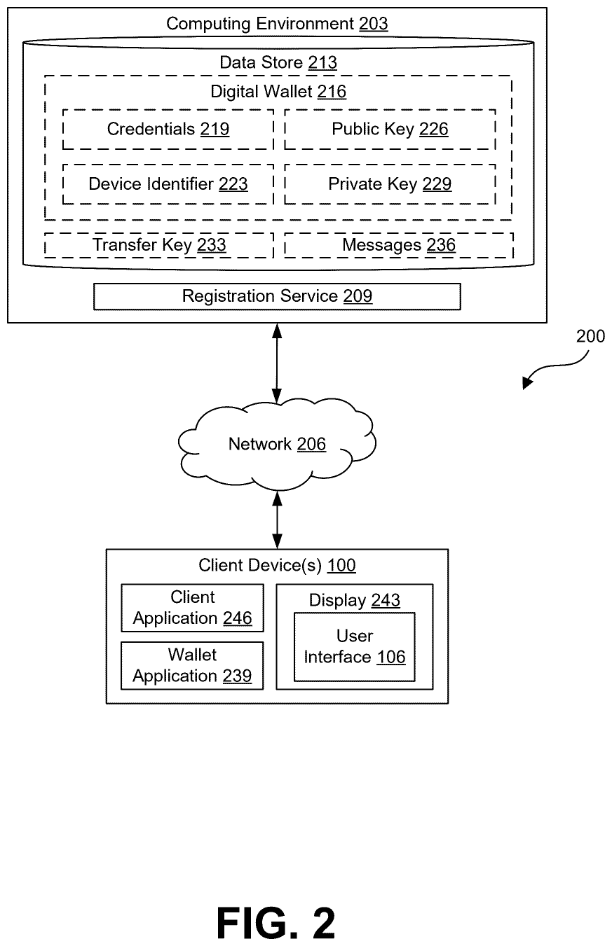

With reference to FIG. 2, shown is a network environment 200 according to various embodiments. The network environment 200 can include a computing environment 203 and one or more client devices 100, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a registration service 209, and other applications, services, processes, systems, engines, or functionality not discussed in detail herein.

The registration service 209 can be executed to register the transfer of a digital wallet with any associated issuers and/or verifiers. The registration service 209 can be associated with an issuer or a verifier or with an institution responsible for hosting wallet-related services. In some examples, the registration service 209 can be executed to write a new block to a blockchain in a blockchain network or other distributed ledger to indicate the transfer and change ownership of a digital wallet from one device to another. In some examples, the registration service 209 can register a transfer with a host server, rewriting over previous data to indicate a new device associated with the wallet.

Also, various data is stored in a data store 213 that is accessible to the computing environment 203. The data store 213 can be representative of a plurality of data stores 213, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 213 is associated with the operation of the various applications or functional entities described below. This data can include digital wallets 216 having one or more credentials 219, a device identifier 223, a public key 226, and a private key 229, a transfer key 233, messages 236, and potentially other data.

The digital wallet 216 can represent a software application hosted on a client device 100 which provides and manages a secure database for various credentials 219. The digital wallet 216 can be representative of a self-sovereign identity (SSI) wallet capable of issuing, holding, and/or verifying credentials 219. In some examples, the digital wallet 216 can include credentials 219, a device identifier 223, a public key 226, and a private key 229. The digital wallet 216 can be managed with a wallet application 239 on a client device 100.

The credentials 219 can be representative of verifiable credentials such as forms of identification, payment methods, certificates, or other forms of verifiable digital information. The credentials 219 can be encrypted and stored within a digital wallet 216 on a client device 100. Each credential 219 can have an associated issuer responsible for having issued the credential 219 and a holder or owner of the digital wallet 216. In some examples, the credentials 219 are associated with a device identifier 223, a public key 226, and/or a private key 229.

A device identifier 223 can be representative of a unique alphanumeric identifier which is specific to the client device 100 on which it is stored. The device identifier 223 can be used to uniquely identify a client device 100 with respect to another client device or computing device. In some examples, the device identifier 223 is unique to a client device 100. However, in some examples, the device identifier 223 is unique to a digital wallet 216.

The public key 226 and the private key 229 can be parts of a public-private or asymmetric cryptographic key-pair used by the digital wallet 216 when issuing credentials 219. The private key 229 can be used to sign any credentials 219 issued, allowing third parties to determine the authenticity of the credential 219. The public key 226 can be provided to any third party that requested the public key 226 in order to verify that a credential 219 signed by the private key 229 is genuine. The public key 226, or a fingerprint of the public key 226 can also be used to uniquely identify a digital wallet 216 or wallet application with respect to other digital wallets 216 or wallet applications.

The transfer key 233 can represent a unique encryption key which is generated based at least in part on the public key 226 of a digital wallet 216. The transfer key 233 can be used to encrypt various information associated with a digital wallet 216 for the purpose of transferring the information. In some examples, the transfer key 233 is unique to the transferring client device 100a and the receiving client device 100b so that the information cannot be intercepted and decrypted by another device. For example, the transfer key 233 can be generated based at least in part on a public key 226 of the digital wallet 216 to be transferred and a public key 226 associated with the receiving client device 100b.

The messages 236 can be representative of a variety of messages to be displayed on a user interface 106. The messages 236 can be generated in response to various actions from a wallet application 239, the registration service 209, or other system, service, or application in the network environment 200. In some examples, messages 236 can include messages, notifications, alerts, graphics, or other forms of information about the progress of a transfer which can be displayed in a user interface 106 to inform the user. The messages 236 can inform the user that a transfer has begun, the transfer is in progress, the transfer has been completed successfully, or that a transfer has experienced an issue. Additionally, messages 236 can include requests for input from the user.

The client device 100 is representative of a plurality of client devices that can be coupled to the network 206. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 243, such as liquid crystal displays (LCDs), gas plasma-based flat panel displays, organic light emitting diode (OLED) displays, electrophoretic ink (“E-ink”) displays, projectors, or other types of display devices. In some instances, the display 243 can be a component of the client device 100 or can be connected to the client device 100 through a wired or wireless connection.

The client device 100 can be configured to execute various applications such as a client application 246, a wallet application 239, or other applications. The client application 246 can be executed in a client device 100 to access network content served up by the computing environment 203 or other servers, thereby rendering a user interface 106 on the display 243. To this end, the client application 246 can include a browser, a dedicated application, or other executable, and the user interface 106 can include a network page, an application screen, or other user mechanism for obtaining user input. The client device 100 can be configured to execute applications beyond the client application 246 such as email applications, social networking applications, word processors, spreadsheets, or other applications.

The wallet application 239 can be executed to manage the digital wallet 216 on a client device 100. For example, the wallet application 239 can manage the addition of new credentials 219, the sending and receiving of data for transactions utilizing the digital wallet 216, as well as the transferring of the digital wallet 216. In some examples, the wallet application 239 can utilize the client device 100 communication capabilities to connect to other devices and exchange information.

Next, a general description of the operation of the various components of the network environment 200 is provided. To begin, a user may open a wallet application 239 on their client device 100a and select to transfer a digital wallet 216. In some examples, the user can be prompted to ‘tap’ their device or otherwise initiate a short-range wireless connection with a second client device 100b. The wallet application 239a of the first device 100a can establish the connection with the wallet application 239b of the second device 100b. After the devices have established the connection, the user of the first device 100a can be prompted to select a digital wallet 216 to be transferred. The user can interact with the user interface 106 as demonstrated in the examples of FIGS. 1A-1C to select the digital wallet 216 to transfer.

After the digital wallet 216 has been identified, the wallet application 239a of the first client device 100a and the wallet application 239b of the second client device 100b can exchange public keys 226. Then, each of the first wallet application 239a and the second wallet application 239b can generate a transfer key 233 to use in completing the transfer of the digital wallet 216. In some examples, the first wallet application 239a can encrypt the private key 229 of the digital wallet 216 using the transfer key 233 and send the encrypted private key 229 to the second wallet application 239b. Upon receipt of the encrypted private key 229, the second wallet application 239b can use the transfer key 233 to decrypt the private key 229. The second wallet application 239b can use the decrypted private key 229 to provision the corresponding digital wallet 216 on the second client device 100b.

The second wallet application 239b can notify the first wallet application 239a that the digital wallet 216 has been established on the second client device 100b. In some examples, the first wallet application 239a can transfer the credentials 219 in response to receiving this notice. However, in some examples, the first wallet application 239a transfers the credentials 219 with the encrypted private key 229. Once the credentials 219 have been stored in the digital wallet 216 on the second client device 100b, the second client device 100b can send a message 236 to the first client device 100a to notify the first client device 100a that the digital wallet 216 has been successfully and completely transferred. Then, one or both client devices 100 can display a transfer-complete message 236 on their respective user interfaces 106 to alert users that the digital wallet 216 has been transferred.

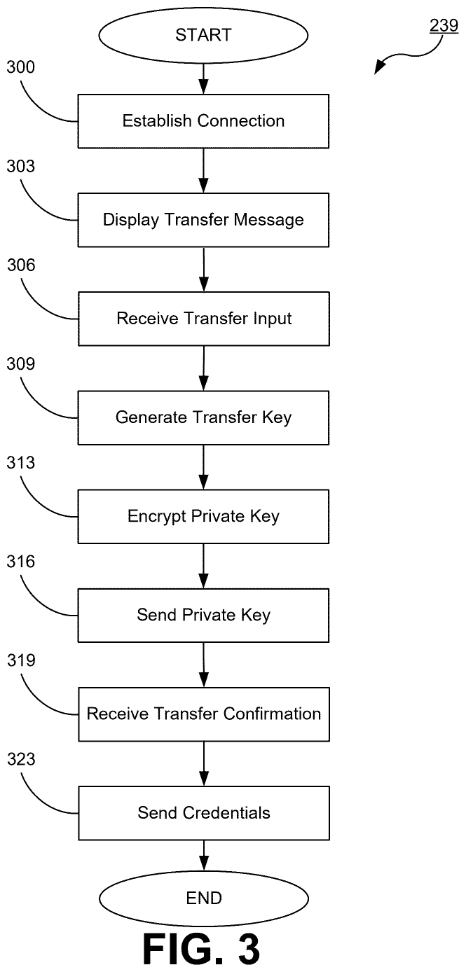

Referring next to FIG. 3, shown is a flowchart that provides one example of the operation of a portion of the wallet application 239 on a transferring client device 100. The flowchart of FIG. 3 provides merely an example of the many different types of functional arrangements that can be employed to implement the operation of the depicted portion of the wallet application 239. As an alternative, the flowchart of FIG. 3 can be viewed as depicting an example of elements of a method implemented within the network environment 200.

Beginning with block 300, the wallet application 239 can be executed to establish a connection. The wallet application 239 can establish a secure short-range connection with a second wallet application 239b of a second client device 100b. In some examples, the first wallet application 239a and the second wallet application 239b can establish a secure short-range wireless connection using near-field communication (NFC) technology supported on the client devices 100. In other examples, the first wallet application 239a and the second wallet application 239b can establish a secure short-range wireless connection with BLUETOOTH®, Wi-Fi, ultra-wideband (UWB), Magnetic Secure Transmission (MST), etc. In some examples, establishing the connection comprises sending and/or receiving signals and verifying that the connection is permissible to both the first wallet application 239a and the second wallet application 239b.

Next, at block 303, the wallet application 239 can be executed to display a transfer message. The transfer message can represent a message 236 from the wallet application 239 to be displayed on the user interface 106 of the client device 100. The transfer message can comprise a request for a user to select a digital wallet 216 to transfer. In some examples, the transfer message can comprise a request for the user's consent to receive a transferred digital wallet 216. The wallet application 239 can cause the transfer message to be displayed in the user interface 106.

At block 306, the wallet application 239 can be executed to receive a transfer input. A transfer input can comprise an input, message, response, or notification indicating a digital wallet 216 to be transferred. The transfer input can originate from a user's interactions with a user interface element 109 on a user interface 106. In some examples, the wallet application 239 can receive the transfer input from the user interface 106. However, in some examples the wallet application 239 can receive the transfer input from another system, service, or application in the network environment 200.

At block 309, the wallet application 239 can be executed to generate a transfer key 233. In some examples, the transfer key 233 is generated based at least in part on the public key 226 of the digital wallet 216 to be transferred. In some examples, the transfer key 233 is generated based at least in part on a public key 226 of the receiving client device 100b. The wallet application 239 can generate the transfer key 233 in response to receiving the transfer input from block 306.

Moving to block 313, the wallet application 239 can be executed to encrypt the private key 229 of the digital wallet 216 to be transferred. Based at least in part on the transfer input from block 306 indicating which digital wallet 216 will be transferred, the wallet application 239 can determine the private key 229 associated with that digital wallet 126 and encrypt the private key 229 using the transfer key 233 generated at block 309.

Next, at block 316, the wallet application 239 can be executed to send the encrypted private key 229. The wallet application 239 can send the encrypted private key 229 from block 313 to the second client device 100b using the connection established at block 300. In some examples, the wallet application 239 can send one or more credentials 219 with the encrypted private key 229. The first wallet application 239a can send the encrypted private key 229 to the second wallet application 239b.

At block 319, the wallet application 239 can be executed to receive a transfer confirmation. The transfer confirmation can comprise a message, notice, alert, or other notification which alerts the wallet application 239 that the transfer of the private key 229, the credentials 219, the digital wallet 216, or any combination of the above has been completed. In some examples, the first wallet application 239a receives the transfer confirmation from the second wallet application 239b after having sent the encrypted private key 229 at block 316. The second wallet application 239b can send the transfer confirmation once the private key 229 has been received and the digital wallet 216 established on the second client device 100b.

Finally, at block 323, the wallet application 239 can be executed to send one or more credentials 219 from the original digital wallet 216. In some examples, the wallet application 239 can send the credentials 219 associated with the digital wallet 216 after the wallet application 239 has received a transfer confirmation regarding the private key 229. However, in some examples, the wallet application 239 can send the credentials 219 along with the encrypted private key 229 at block 316. The first wallet application 239a can send the credentials 219 associated with the digital wallet 216 identified from the transfer input at block 306 to the second wallet application 239b using the connection established at block 300. After block 323, the flowchart of FIG. 3 can end.

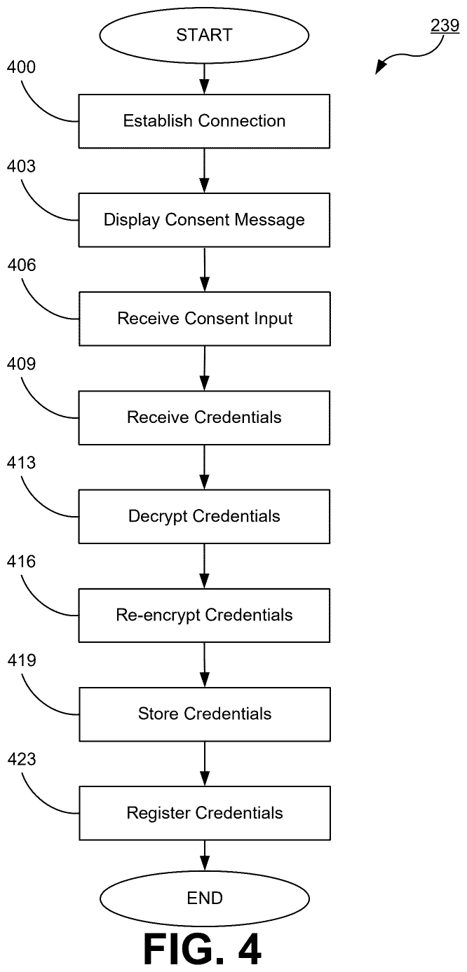

Referring next to FIG. 4, shown is a flowchart that provides one example of the operation of a portion of the wallet application 239 on a receiving client device 100. The flowchart of FIG. 4 provides merely an example of the many different types of functional arrangements that can be employed to implement the operation of the depicted portion of the wallet application 239. As an alternative, the flowchart of FIG. 4 can be viewed as depicting an example of elements of a method implemented within the network environment 200.

Beginning with block 400, the wallet application 239 can be executed to establish a connection. As described above in the discussion of block 330 of FIG. 3, the wallet application 239 can establish a secure short-range connection with a second wallet application 239b of a second client device 100b. In some examples, the first wallet application 239a and the second wallet application 239b can establish a secure short-range wireless connection using near-field communication (NFC) technology supported on the client devices 100. In some examples, the first wallet application 239a and the second wallet application 239b can establish a secure short-range wireless connection with BLUETOOTH®, Wi-Fi, ultra-wideband (UWB), Magnetic Secure Transmission (MST), etc. In some examples, establishing the connection comprises sending and/or receiving signals and verifying that the connection is permissible to both the first wallet application 239a and the second wallet application 239b.

Next, at block 403, the wallet application 239 can be executed to display a consent message. In response to establishing the connection at block 400, the wallet application 239 can be configured to generate a consent message. The consent message can be representative of a message 236 which indicates to the user of the client device 100 that a digital wallet 216 is going to be transferred to the client device 100 and requests a consent from the user. The wallet application 239 can cause the consent message to be displayed on a user interface 106 of the client device 100.

Next, at block 406, the wallet application 239 can be executed to receive a consent input. A consent input can comprise an input, message, response, or notification indicating consent to the transfer of a digital wallet 216. The consent input can be received in response to having displayed the consent message at block 403. In some examples, the wallet application 239 can receive the consent input from the user interface 106 of the client device 100.

At block 409, the wallet application 239 can be executed to receive one or more credentials 219. In some examples, the wallet application 239 receives the credentials 219 from a second wallet application 239b. The credentials 219 can be associated with the digital wallet 216 being transferred. In some examples, the first wallet application 239a can request the credentials 219 from the second wallet application 239b. In some examples, the wallet application 239 can receive the one or more credentials 219 in response to having received the consent input at block 406.

Next, at block 413, the wallet application 239 can be executed to decrypt the credentials 219. The wallet application 239 can decrypt the one or more credentials 219 received at block 409 using a transfer key 233. The transfer key 233 can be unique to the first wallet application 239a and the second wallet application 239b and generated in response to the connection established at block 400. The credentials 219 from the second wallet application 239b can be encrypted with the transfer key 233. Thus, the first wallet application 239a can decrypt the credentials 219 using the transfer key 233.

At block 416, the wallet application 239 can be executed to re-encrypt the credentials 219. Once the credentials 219 have been decrypted with the transfer key 233 at block 413, the wallet application 239 can re-encrypt the credentials 219 using the private key 229 associated with the wallet application 239. In some examples, the wallet application 239 re-encrypts the credentials 219 using the private key 229 associated with the digital wallet 216.

Moving to block 419, the wallet application 239 can be executed to store the credentials 219. The wallet application 239 can store the credentials 219 in a digital wallet 216 configured based at least in part on the consent input from block 406. The wallet application 239 can generate the digital wallet 216 based at least in part on the re-encrypted credentials 219 and store the re-encrypted credentials 219 in the digital wallet 216. In some examples, the wallet application 239 can store the re-encrypted credentials 219 in an existing digital wallet 216.

Next, at block 423, the wallet application 239 can be executed to register the one or more credentials 219. In some examples, the wallet application 239 registers the re-encrypted credentials 219 from block 416 with a new device identifier 223 and/or a new private key 229. The wallet application 239 can communicate directly with an issuer and/or a verifier to register the credentials 219, or in some examples, can send a registration request to a registration service 209 to register the credentials 219. After block 423, the flowchart of FIG. 4 can end.

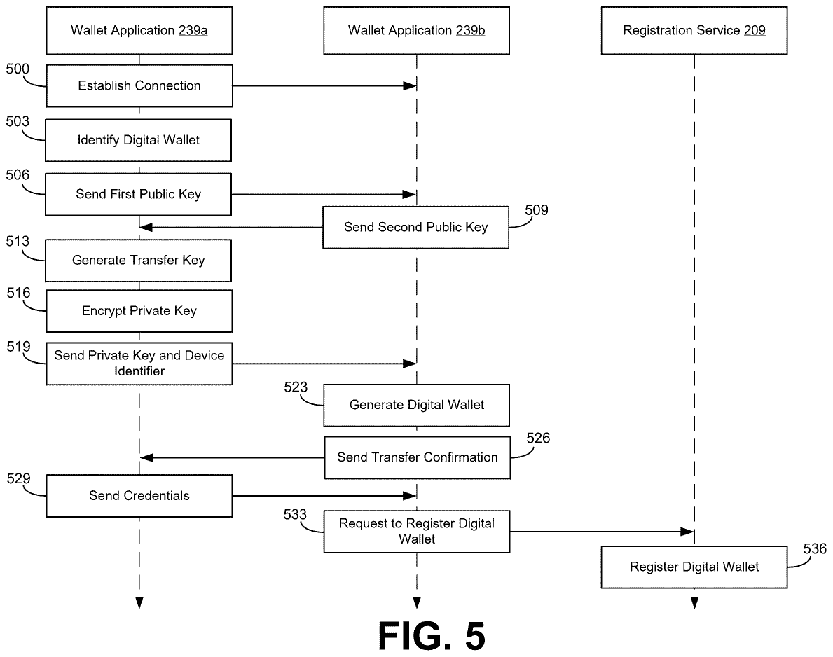

Referring next to FIG. 5, shown is a sequence diagram that provides one example of the operation of the interactions between a first wallet application 239a, a second wallet application 239b, and a registration service 209. The sequence diagram of FIG. 5 provides merely an example of the many different types of functional arrangements that can be employed to implement the operations of the depicted portions of the first wallet application 239a, the second wallet application 239b, and the registration service 209. As an alternative, the sequence diagram of FIG. 5 can be viewed as depicting an example of elements of a method implemented within the network environment 200.

Beginning with block 500, the first wallet application 239a can establish a connection with the second wallet application 239b. Further details on the establishment of the connection can be found in the discussion of block 300 of FIG. 3 and block 400 of FIG. 4.

Next, at block 503, the first wallet application 239a can identify a digital wallet 16. The first wallet application 239a can identify the digital wallet 216 to be transferred to the second wallet application 239b based at least in part on a user input through a user interface 106. In some examples, the first wallet application 239a can identify the digital wallet 216 to be transferred from a data store 213 or other system, service, or application in the network environment 200.

Moving to block 506, the first wallet application 239a can be executed to send a first public key 226. The first public key 226 can be associated with the digital wallet 216 identified at block 503. In some examples, the first wallet application 239a sends the first public key 226 in response to identifying the digital wallet 216 at block 503. The first wallet application 239a can send the first public key 226 to the second wallet application 239b over the connection established at block 500.

Next, at block 509, the second wallet application 239b can be executed to send a second public key 226. The second public key 226 can be associated with the second client device 100b. In some examples, the second wallet application 239b sends the second public key 226 in response to receiving the first public key at block 506. The second wallet application 239b can send the second public key 226 to the first wallet application 239a over the connection established at block 500.

At block 513, the first wallet application 239a can be executed to generate a transfer key 233. In some examples, the first wallet application 239a and the second wallet application 239b both generate the same transfer key 233 based at least in part on the exchange of public keys 226 at blocks 506 and 509. The first wallet application 239a can generate the transfer key 233 based at least in part on the first public key 226 and the second public key 226.

At block 516, the first wallet application 239a can be executed to encrypt a private key 229 associated with the digital wallet 216 to be transferred. In some examples, the first wallet application 239a encrypts the private key 229 using the transfer key 233 generated at block 513. The first wallet application 239a can encrypt the private key 229 to generate an encrypted private key 229.

At block 519, the first wallet application 239a can be executed to send the private key 229 and, in some examples, the device identifier 223 associated with the digital wallet 216. The first wallet application 239a can use the encrypted private key 229 from block 516 to send to the second wallet application 239b. The encrypted private key 229 can be sent using the connection established at block 500. In some examples, the first wallet application 239a can also encrypt the device identifier 223 associated with the digital wallet 216. The first wallet application 239a can send the device identifier 223 and the private key 229 at the same time or at separate times to the second wallet application 239b.

Moving to block 523, the second wallet application 239b can be executed to generate the transferred digital wallet 216 on the second client device 100b. Using at least the encrypted private key 229 sent at block 519, the second wallet application 239b can generate the transferred digital wallet 216 on the new client device 100b. The second wallet application 239b can decrypt the private key 229 using the transfer key 233 and use the decrypted private key 229 to initialize the digital wallet 216. In some examples, the second wallet application 239b generates the digital wallet 216 based at least in part on the device identifier 223 from block 519.

Next, at block 526, the second wallet application 239b can be executed to send a transfer confirmation. The transfer confirmation can comprise a message, notice, alert, or other notification which alerts the wallet application 239 that the transfer of the private key 229, the credentials 219, the digital wallet 216, or any combination of the above has been completed. In some examples, the second wallet application 239b sends the transfer confirmation to the first wallet application 239a after generating the digital wallet 216 at block 523.

At block 529, the first wallet application 239a can send one or more credentials 219. Based at least in part on the digital wallet 216 identified at block 503, the first wallet application 239a can identify one or more credentials 219 associated with the digital wallet 216 and send the credentials to the second wallet application 239b to be stored in the transferred digital wallet 216. In some examples, the first wallet application 239a encrypts the one or more credentials 219 using the transfer key 233 to send encrypted credentials 219 to the second wallet application 239b. The first wallet application 239a can send the credentials 219 to finalize the transfer of the digital wallet 216.

Next, at block 533, the second wallet application 239b can be executed to request to register the digital wallet 216. Once the second wallet application 239b receives the credentials 219 from the first wallet application 239a at block 529, the second wallet application 239b can store the credentials 219 in the digital wallet 216 and finalize the transfer of the digital wallet 216. The second wallet application 239b can send a registration request to the registration service 209 to have the transfer recorded with the appropriate entities, such as the issuer and/or the verifier. In some examples, the request includes an authorization to transfer from the first wallet application 239a.

At block 536, the registration service 209 can receive the request from the second wallet application 239b to register the digital wallet 216 transfer. In some examples, the registration service 209 can re-register the digital wallet 216 with a new key pair from the second client device 100b to override a registration with an old key pair from the first client device 100a. In some examples, the registration service 209 can write a new block to a blockchain, describing the new location and ownership of the digital wallet 216. In some examples, the registration service 209 can re-register the digital wallet 216 by replacing a first device identifier 223a associated with the first client device 100a with a second device identifier 223b associated with the second client device 100b. After block 536, the sequence diagram of FIG. 5 can end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a first computing device comprising a processor and a memory; and
machine-readable instructions stored in the memory that, when executed by the processor, cause the first computing device to at least:
establish a connection with a second computing device;
identify a digital wallet to be transferred, the digital wallet having a first public key and a private key;
send the first public key to the second computing device;
receive a second public key from the second computing device;
generate a transfer key based at least in part on the first public key and the second public key;
generate an encrypted private key using the transfer key;
transfer one or more encrypted credentials associated with the digital wallet to the second computing device; and
send the encrypted private key to the second computing device, wherein the encrypted private key can be decrypted using at least a key generated by the second computing device.

2. The system of claim 1, wherein the machine-readable instructions which cause the first computing device to generate the encrypted private key further cause the first computing device to at least
encrypt the private key of the digital wallet using the transfer key to generate the encrypted private key.

3. The system of claim 1, wherein the machine-readable instructions which cause the first computing device to identify the digital wallet to be transferred, further cause the first computing device to at least:
display a transfer message on a user interface; and
receive a transfer input from the user interface, the transfer input indicating the digital wallet to be transferred.

4. The system of claim 1, wherein the machine-readable instructions further cause the first computing device to at least:
receive a transfer confirmation from the second computing device; and
display a transfer confirmation message on a user interface.

5. The system of claim 4, wherein the machine-readable instructions further cause the first computing device to at least generate the one or more encrypted credentials associated with the digital wallet by at least encrypting one or more credentials using at least the transfer key.

6. The system of claim 1, wherein the machine-readable instructions which cause the first computing device to send the encrypted private key, further cause the first computing device to at least send a device identifier associated with the first computing device to the second computing device.

7. The system of claim 1, wherein the machine-readable instructions further cause the first computing device to at least register the private key with a device identifier associated with the second computing device.

8. A method, comprising:
establishing, by a first computing device, a connection with a second computing device;
identifying, by the first computing device, a digital wallet to be transferred, the digital wallet having a first public key and a private key;
sending the first public key to the second computing device;
receiving a second public key from the second computing device;
generating a transfer key based at least in part on the first public key and the second public key;
generating, by the first computing device, an encrypted private key using the transfer key;
transferring one or more encrypted credentials associated with the digital wallet to the second computing device; and
sending, by the first computing device, the encrypted private key to the second computing device, wherein the encrypted private key can be decrypted using at least a key generated by the second computing device.

9. The method of claim 8, where generating the encrypted private key further comprising
encrypting, by the first computing device, the private key of the digital wallet using the transfer key to generate the encrypted private key.

10. The method of claim 8, wherein identifying the digital wallet to be transferred further comprises:
displaying, by the first computing device, a transfer message on a user interface; and
receiving, by the first computing device, a transfer input from the user interface, the transfer input indicating the digital wallet to be transferred.

11. The method of claim 8, further comprising:
receiving, by the first computing device, a transfer confirmation from the second computing device; and
displaying, by the first computing device, a transfer confirmation message on a user interface.

12. The method of claim 11, further comprising generating, by the first computing device, the one or more encrypted credentials associated with the digital wallet by at least encrypting one or more credentials using at least the transfer key.

13. The method of claim 8, wherein sending the encrypted private key, further comprises sending, by the first computing device, a device identifier associated with the first computing device to the second computing device.

14. The method of claim 8, further comprising registering, by the first computing device, the private key with a device identifier associated with the second computing device.

15. A system, comprising:
a first computing device comprising a processor and a memory; and
machine-readable instructions stored in the memory that, when executed by the processor, cause the first computing device to at least:
establish a secure connection with a second computing device;
receive a first public key from the second computing device;
send a second public key to the second computing device;
receive one or more credentials from the second computing device, the one or more credentials to be stored in a digital wallet on the first computing device, wherein the one or more credentials are encrypted based at least in part by a key generated by the first computing device;
generate a transfer key based at least in part on the first public key and the second public key;
decrypt the one or more credentials using the transfer key;
re-encrypt the one or more credentials using a key pair associated with the digital wallet; and
store the one or more credentials in the digital wallet.

16. The system of claim 15, wherein the transfer key is identical to the key.

17. The system of claim 15, wherein the machine-readable instructions further cause the first computing device to at least register the one or more credentials with a registration service.

18. The system of claim 17, wherein the machine-readable instructions which cause the first computing device to register the one or more credentials, further cause the first computing device to at least:
receive an authorization to transfer from the second computing device; and
send the authorization to transfer, one or more credential identifiers corresponding to the one or more credentials, and a wallet identifier corresponding to the digital wallet to the registration service.

19. The system of claim 15, wherein the machine-readable instructions further cause the first computing device to at least:
display a transfer consent message on a user interface;
receive a consent input from the user interface; and
send a request for the one or more credentials to the second computing device.

20. The system of claim 19, wherein the consent input identifies the digital wallet to receive the credentials.
